(19) United States
(12) Patent Application Publication
(10) Pub. No.: US 2012/0145276 A1
(43) Pub. Date: Jun. 14, 2012

(54) PIPELINE WITH AN INTERNAL CORROSION RESISTANT METAL COATING

(75) Inventors: Håvard Ilstad, Trondheim (NO); Erik Levold, Trondheim (NO); Carl Henrik Ahlen, Trondheim (NO)

(73) Assignee: STATOIL PETROLEUM AS, Stavanger (NO)

(21) Appl. No.: 13/318,786

(22) PCT Filed: May 6, 2010
(86) PCT No.: PCT/NO2010/000173

§ 371 Date: Jan. 5, 2012

(30) Foreign Application Priority Data
May 6, 2009 (NO) 20091803

(51) Int. Cl. F16L 9/14; B32B 37/14

(52) U.S. Cl. 138/140; 156/294

(57) ABSTRACT

A pipeline comprising an outer steel pipe and an internal corrosion resistant covering adhesively joined to the inside of the steel pipe. The pipeline can be taken up onto a drum and later unwound and laid out without any observed deformation of the metal covering. A method for the manufacturing of the pipeline comprises the steps of applying an adhesive onto the outside of the metal covering and optionally also onto the inside of the steel pipe, inserting the metal covering into the pipe and expanding the covering until being in a good contact with the inside of the steel pipe, and curing the adhesive to make the metal covering adhere tightly to the inside of the steel pipe.

### FIELD OF INVENTION

The present invention relates to a steel pipeline having on its inside surface a corrosion resistant metal covering. In particular, the present invention relates to such a pipeline and a method for the manufacturing thereof. The pipeline is suited for being taken up onto a drum, and for subsequent pipelay on the seabed from a pipelay vessel.

### BACKGROUND AND PRIOR ART

With an increasing need for the transport of unprocessed well streams from subsea installations, and with a more frequent occurrence of aggressive fluids to be transferred, there is an increasing demand for corrosion resistant pipelines. However, corrosion resistant pipelines have contributed to a dramatic increase in costs, and therefore less expensive options are searched for.

Such a less expensive alternative is a pipeline made from carbon steel having on its inside a more corrosion resistant covering. This covering may be termed lining, coating or cladding. In this way the strength of the carbon steel is combined with the corrosion resistance of the inside covering. The covering is typically manufactured from a corrosion resistant steel, also termed stainless steel, and the covering is typically of a thickness from 1 to 7 mm, most often about 3 mm. The covering is arranged against the inside surface of the carbon steel pipeline, either by hot rolling (roll welding), welding, brazing or clad welding. The obviously least expensive embodiment is to have an internal covering in a mechanically close contact with the inside surface of the carbon steel pipeline to obtain a metal contact without any voids between the pipe and covering. However, experience has proved that such a design is not suitable for a pipeline which shall be laid out from a drum on board a pipelay vessel, because the internal covering will become deformed by buckling or wrinkling, most probably followed by cracking. With such deformations the internal covering will loosen from the inside surface of the steel pipeline, and the covering will no longer be able to resist the stress occurring during the operation of the pipeline. A solution to this problem is proposed in Norwegian patent application NO 2006 5686, which teaches the use of an internal overpressure to prevent fracturing. The required overpressure has proven to be relatively low, in the range of 5 to 25 bar, and a gas such as air, or a liquid such as water, may be used. Experience has shown that this method will work satisfactorily; however, the necessary gas volumes will be relatively big. This procedure also involves problems related to health, environment and safety, and the procedure is comprehensive and time consuming. The arrangement of sealings to maintain the required pressures is also a demanding task.

Consequently, alternative solutions are sought for. In particular, there is a demand for a pipeline which will not be deformed in any way when being laid out on the seabed from a drum on a pipelay vessel. Moreover, it is also important to lay out the pipeline without deformations in a more simple way than today. In addition, a method for the manufacturing of such a pipeline is needed.

### SUMMARY OF THE INVENTION

The present invention solves the problems indicated above.

In particular, the present invention relates to a pipeline having an internal corrosion resistant covering arranged tightly to the inside of the surrounding pipe. The pipeline comprises an outer steel pipe, a corrosion resistant covering on the inside thereof, and an adhesive layer adhering the metal covering to the inside of the steel pipe to obtain that the pipeline can withstand the lay out on the seabed from a drum on a pipelay vessel without the metal covering inside the laid out pipeline being deformed.

The invention also provides a method for the manufacturing of a pipeline having an internal corrosion resistant metal covering which is arranged tightly to a surrounding steel pipe material by applying an adhesive onto the outside of the metal covering and optionally also onto the inside of the steel pipe, inserting the metal covering into the steel pipe and expand it until being in a good contact with the inside of the steel pipe, and curing the adhesive to make the metal covering adhere tightly to the inside of the steel pipe.

### DETAILED DESCRIPTION

In this specification all terms used have their common meanings. However, some terms may need being explained. “Closely arranged” means that an adhesive only is present between the covering and the surrounding pipe material. “Winding” means that the pipeline is suited for being taken up onto a drum for later unwinding from the drum, without any problems of buckling of the covering. “Adhesion” means that the covering is adhesively attached, with the adhesive, to the external pipe material with a sufficient adhesion to prevent occurrence of any buckling during winding onto a drum, and subsequently unwinding from the drum.

The pipeline of the present invention consists of an outer steel pipe, having an internal corrosion resistant covering, and there between an adhesive which keeps the internal covering adhered to the inside of the external steel pipe.

In the final pipeline the external material is carbon steel of the common types used in carbon steel pipelines, such as those selected according to the standards of The American Petroleum Institute (API) or Det Norske Veritas (DNV). The steel pipe as such is of a thickness substantially greater than the thickness of the internal corrosion resistant covering, because the pipeline is so dimensioned that the external pipe material will be able to resist/absorb all occurring mechanical stress.

The internal corrosion resistant covering consist of a metal material typically selected from all suitable types of stainless steel; and also materials which are more corrosion resistant than the metal material used in the external steel pipe. A typical thickness of the internal corrosion resistant metal covering is in the range of 1 to 7 mm, preferably about 3 mm, but the thicknesses may deviate from these values. A pipeline of a greater diameter requires a metal covering of increased thickness to maintain mechanical integrity.

The internal corrosion resistant covering will, as a rule, be in the shape of a pipe section. Alternatively it may be in the shape of a band made from a stainless material, which band is wound with overlap inside the external pipeline section using a tool suited for the purpose.

The adhesive used for the purpose may be a common thermal curing adhesive, that is to say the adhesive cures when exposed to heat, or the used adhesive may cure at ambient temperature and humidity. An adhesives which cures by contact may also be used because there will occur a substantial contact pressure between the internal covering and the external pipe during the manufacturing process. The adhesive layer must have a tensile strength typically in the range of 0.1 to 1.0 N/mm².

The steel pipes which shall be provided with an internal covering will usually be of a standard length of 12.2 meters (40 ft); optionally, several such lengths may be welded together. The covering to be applied onto the internal wall of the external pipe is also usually in the shape of pipe sections of the same length as the external pipe. In the process of the present invention, the first step is to make each pipe section ready with an internal covering. This is obtained by applying the adhesive onto the external surface of the section of corrosion resistant covering, and if deemed necessary an adhesive may also be applied onto the inside surface of the external pipe, and then the covering is inserted into the steel pipe. The covering is then shaped into the shape of the steel pipe by applying an internal pressure using water, gas or a mechanical tool to force the covering outwards into a good contact with the steel pipe. The expansion mechanism can be combined with a simultaneous heating of the external pipe. This will then bring the adhesive to cure. Upon cooling the external pipe will contract, and thus an additional high contact pressure will also be achieved. The heat setting of the adhesive can also be obtained during other steps of the manufacturing process, for example during the step of applying an external corrosion resistant coating or insulation onto the pipeline, during which process the pipe is typically heated to about 250° C. in a short period of time.

When the covering has been attached as explained above, each end of the covering is welded to the external pipe. Subsequently, all such finished pipe sections are welded together by any well known procedure into a pipeline of desired length. Finally, the pipeline is winded onto one or more drums and will thus be ready for being laid out onto the seabed.

Tests have revealed that the corrosion resistant covering inside the final, laid out pipeline on the seabed is without any buckling or cracks, and has an excellent adhesion to the external pipe.

1. A pipeline comprising:
an internal corrosion resistant covering arranged tightly to the inside of an outer surrounding pipe material,
wherein the pipeline comprises an outer steel pipe, an internal corrosion resistant covering and an adhesive layer, the adhesive layer adhering the metal covering to the inside of the steel pipe to obtain a pipeline that will withstand lay out on the seabed from a drum on a pipelay vessel, without the metal covering the inside of the laid out pipeline being deformed.

2. The pipeline of claim 1, wherein the adhesive layer consists of an adhesive which cures when being subjected to heat and/or pressure.

3. The pipeline of claim 1, wherein the metal covering is in the shape of one or more pipe sections having a wall thickness of up to 7 mm.

4. A method for the manufacturing of a pipeline having an internal corrosion resistant metal covering arranged tightly to a surrounding steel pipe material, the method comprising the steps of:
applying an adhesive onto at least one of the outside of the metal covering and the inside of the steel pipe;
inserting the metal covering into the steel pipe and expanding the metal covering until the metal covering is in good contact with the inside of the steel pipe; and
curing the adhesive to make the metal covering adhere tightly to the inside of the steel pipe.

5. The method according to claim 4, wherein the adhesive is an adhesive which cures by contact, by pressure and/or by heat.

6. The method according to claim 5, wherein the adhesive cures during a heat treatment of the external steel pipe.

7. The method according to claim 4, wherein both the steel pipe and the metal covering are pipe sections of a definite length which are joined together by the use of an adhesive.

8. The method according to claim 4, wherein the finished pipe sections with an internal corrosion resistant covering are welded together into a pipeline of a desired length and taken up onto at least one drum for subsequent pipelay of the pipeline.

9. The method according to claim 5, wherein the finished pipe sections with an internal corrosion resistant covering are welded together into a pipeline of a desired length and taken up onto at least one drum for subsequent pipelay of the pipeline.

10. The method according to claim 6, wherein the finished pipe sections with an internal corrosion resistant covering are welded together into a pipeline of a desired length and taken up onto at least one drum for subsequent pipelay of the pipeline.

11. The method according to claim 7, wherein the finished pipe sections with an internal corrosion resistant covering are welded together into a pipeline of a desired length and taken up onto at least one drum for subsequent pipelay of the pipeline.
